(19) United States
(12) Patent Application Publication
(10) Pub. No.: US 2025/0183524 A1
(43) Pub. Date: Jun. 5, 2025

(54) DEVICE FOR INSTALLING A SHARK FIN ANTENNA ON A VEHICLE AND A METHOD OF ASSEMBLING A VEHICLE USING SAME

(71) Applicants: HYUNDAI MOTOR COMPANY, Seoul (KR); KIA CORPORATION, Seoul (KR)

(72) Inventors: Ji Hoon Yu, Bucheon-si (KR); Jung Whan Yeum, Seoul (KR)

(73) Assignees: HYUNDAI MOTOR COMPANY, Seoul (KR); KIA CORPORATION, Seoul (KR)

(21) Appl. No.: 18/673,925

(22) Filed: May 24, 2024

(30) Foreign Application Priority Data
Nov. 30, 2023 (KR) 10-2023-0171058

(51) Int. Cl. H01Q 1/32; B25J 15/06; H01Q 3/02

(52) U.S. Cl. CPC H01Q 1/3275; B25J 15/0616; H01Q 3/02

(57) ABSTRACT

The present disclosure relates to a device for installing a shark fin antenna on a vehicle and a method of assembling a vehicle using the same. The assembly device includes a gripper configured to be multiaxially movable. The gripper includes: an alignment frame to support the outer side of a shark fin antenna; a gripping module disposed in the alignment frame and configured to grip the shark fin antenna; and an inspection module configured to inspect whether the shark fin antenna is assembled at a predetermined position on a vehicle.

### CROSS-REFERENCE TO RELATED APPLICATION

The present application claims priority to Korean Patent Application No. 10-2023-0171058, filed on Nov. 30, 2023, the entire contents of which are incorporated herein for all purposes by this reference.

### TECHNICAL FIELD

The present disclosure relates to a vehicle and, more particularly, to a device for installing a shark fin antenna on a vehicle and a method of assembling a vehicle using the same.

### BACKGROUND

A shark fin antenna is a communication device installed on a vehicle. As shown in FIG. 1, a shark fin antenna 10 is installed at a rear portion of a roof 2 of a vehicle 1. Particularly, a mounting portion M for mounting the shark fin antenna 10 is provided at the rear portion of the roof 2.

The shark fin antenna 10 is manually mounted by a technician. Specifically, the technician passes through the space 6 in which a rear glass is to be mounted and then installs the shark fin antenna 10 in a mounting portion M when a tailgate 4 of the vehicle 1 is opened.

Thus, installing the shark fin antenna 10 presents a challenge because the required working height is high and the space is narrow, low, or confined. In this regard, automation would be beneficial, but achieving automation has proven elusive due to the complexity associated with gripping the shape of the shark fin antenna.

### SUMMARY

The present disclosure, devised to solve the problems described above, provides a device for installing a shark fin antenna on a vehicle.

The present disclosure is to provide an assembly system that may automate assembling a shark fin antenna on a vehicle.

The present disclosure is to provide a method of assembling a vehicle that has an automated assembly process for mounting a shark fin antenna.

The objectives of the present disclosure are not limited to the objectives mentioned above. Other objectives not mentioned herein should be more clearly understood by one having ordinary skill in the art to which the present disclosure pertains from the following description.

In order to achieve the objectives of the present disclosure as described above and to perform the characteristic functions of the present disclosure as described hereinafter, the features of the present disclosure are as follows.

An assembly device according to an embodiment of the present disclosure may include a gripper configured to be multiaxially movable. The gripper may include an alignment frame configured to support an outer side of a shark fin antenna and a gripping module disposed in the alignment frame and configured to grip the shark fin antenna. The gripper may also include an inspection module configured to inspect whether the shark fin antenna is assembled at a predetermined position on a vehicle.

An assembly system for a vehicle according to an embodiment of the present disclosure may include a pallet where a shark fin antenna, which is to be assembled, is provided to a supplied vehicle. In addition, the system may include an assembly device configured to be rotatable and movable such as to pick up the shark fin antenna from the pallet.

A method of assembling a vehicle according to an embodiment of the present disclosure may include automatically assembling a shark fin antenna an a vehicle by an assembly device.

According to the present disclosure, an assembly device is provided that enables a shark fin antenna to be easily assembled on a vehicle.

According to the present disclosure, an assembly system is provided that automates assembling a shark fin antenna on a vehicle.

According to the present disclosure, an assembly method for a vehicle is provided that has an automated assembly process of a shark fin antenna.

The effects of the present disclosure are not limited to those described above. Other effects not mentioned herein may be more clearly understood by those having ordinary skill in the art from the present disclosure.

### BRIEF DESCRIPTION OF THE DRAWINGS

The above and other objectives, features, and other advantages of the present disclosure should be more clearly understood from the following detailed description when taken in conjunction with the accompanying drawings.

FIG. 1 illustrates a vehicle.

FIG. 2 illustrates a shark fin antenna.

FIG. 3 illustrates a mounting surface of a shark fin antenna according to an embodiment of the present disclosure where a part of the shark fin antenna has been omitted.

FIG. 4 schematically illustrates a layout of an assembly system according to an embodiment of the present disclosure.

FIG. 5 illustrates an assembly device of a vehicle according to an embodiment of the present disclosure.

FIG. 6 illustrates a perspective view of a gripper according to an embodiment of the present disclosure.

FIGS. 7 and 8 illustrate an alignment frame of a gripper according to an embodiment of the present disclosure.

FIG. 9 illustrates an interior of an alignment frame of a gripper according to an embodiment of the present disclosure.

FIG. 10 illustrates an original location of a gripping module of a gripper according to an embodiment of the present disclosure.

FIG. 11 illustrates a state in which a gripping module of a gripper according to an embodiment of the present disclosure is pushed by a shark fin antenna.

FIG. 12 illustrates a state in which a part of a gripper according to an embodiment of the present disclosure has been omitted.

FIG. 13 illustrates a gripping module of a gripper and a stopper housing according to an embodiment of the present disclosure.

FIG. 14 illustrates a gripping module of a gripper according to an embodiment of the present disclosure.

FIG. 15 illustrates a state in which a spring is removed from a gripping module of a gripper according to an embodiment of the present disclosure.

FIG. 16 illustrates a top perspective view of a pair of alignment frames of a gripper according to an embodiment of the present disclosure.

FIG. 17 illustrates a bottom perspective view of a pair of alignment frames of a gripper according to an embodiment of the present disclosure.

FIG. 18 illustrates an unclamping state of a pair of alignment frames of a gripper according to an embodiment of the present disclosure.

FIG. 19 illustrates a clamping state of a pair of alignment frames of a gripper according to an embodiment of the present disclosure.

FIG. 20 illustrates an operation of a support portion of a gripper according to an embodiment of the present disclosure.

FIG. 21 illustrates a state in which a shark fin antenna is connected to a vehicle by a quick connector according to an embodiment of the present disclosure.

FIG. 22 illustrates an inspection module of a gripper according to an embodiment of the present disclosure.

FIG. 23 illustrates a state in which an inspection module of a gripper is temporarily coupled to a shark fin antenna according to an embodiment of the present disclosure.

FIGS. 24-29 illustrate an operation process of an inspection module of a gripper according to an embodiment of the present disclosure.

FIG. 30 illustrates a circuit included in an inspection module of a gripper according to an embodiment of the present disclosure.

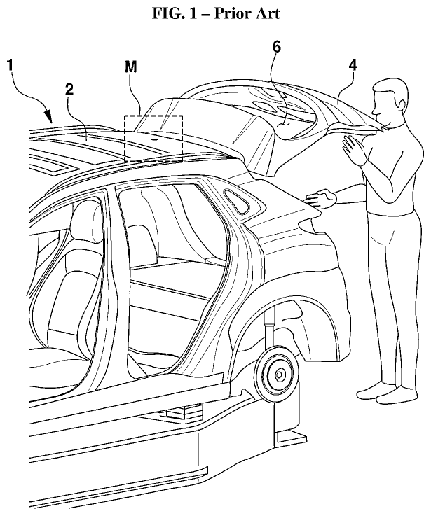

### DETAILED DESCRIPTION

Specific structural or functional descriptions presented in the embodiments of the present disclosure are exemplified only for the purpose of explaining the embodiments according to the concept of the present disclosure. The embodiments according to the concept of the present disclosure may be implemented in various forms. In addition, the present disclosure should not be construed as being limited to the embodiments described in the present specification. The embodiments should be understood to include all modifications, equivalents, or substitutes within the spirit and technical scope of the present disclosure.

Terms such as first and/or second in the present disclosure may be used to describe various components, but the components are not limited to the above terms. These terms are intended only to distinguish one component from other components. Within the scope of the rights according to the concept of the present disclosure, the first component may be referred to as the second component, and similarly the second component may be referred to as the first component.

When it is stated that a component is “connected to” or “in contact with” another component, it should be understood that it may be directly connected to or in contact with that other component, but another component may exist in the middle. On the other hand, when it is stated that one component is “directly connected to” or “in direct contact with” another component, it should be understood that no other component exists in between the noted components. Other expressions to describe the relationship between components, such as “between” and “directly between” or “adjacent to” and “directly adjacent to” should be interpreted similarly.

Throughout the overall specification, the same reference numerals denote the same elements. The terms used herein are for describing the embodiments and are not intended to limit the present disclosure. In the present disclosure, the singular form also includes the plural form unless specifically mentioned in the phrase. As used in the specification, “comprises” and/or “comprising” means that the mentioned components, steps, operations, and/or elements do not exclude the presence or addition of one or more other elements, steps, operations, and/or elements.

When a controller, component, device, element, part, unit, module, or the like of the present disclosure is described as having a purpose or performing an operation, function, or the like, the controller, component, device, element, part, unit, or module should be considered herein as being “configured to” meet that purpose or perform that operation or function. Each controller, component, device, element, part, unit, module, and the like may separately embody or be included with a processor and a memory, such as a non-transitory computer-readable media, as part of the apparatus.

Hereinafter, the present disclosure is described in detail with reference to the accompanying drawings.

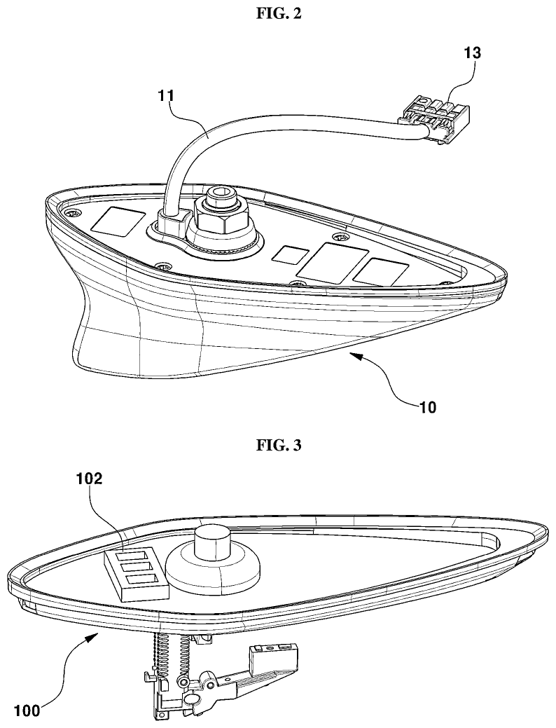

As shown in FIG. 2, a shark fin antenna 10 may be connected to a vehicle 1. To this end, conventionally, the shark fin antenna 10 is connected to a cable 11, and a connector 13 mounted on the end of the cable 11 is connected to the vehicle 1.

According to the present disclosure, the cable 11 may be omitted from a shark fin antenna 10. As shown in FIG. 3, a shark fin antenna 100 may be provided with a quick connector. The quick connector may be provided on the shark fin antenna 100 without the cable 11. The quick connector provided on the shark fin antenna 100 may be a female connector 102. Such a quick connector type of the shark fin antenna 100 may be automatically assembled by an assembly device 300.

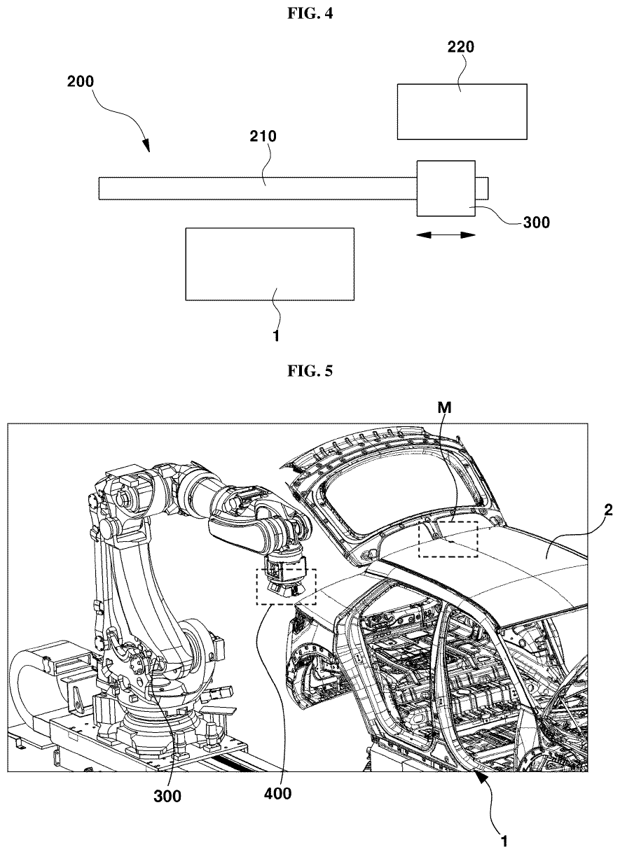

FIG. 4 illustrates a layout of an assembly system 200 according to an embodiment of the present disclosure. An assembly device 300 may assemble the shark fin antenna 100 on a vehicle 1. In an embodiment, the assembly device 300 may be a multi-axis robot. The assembly device 300 is configured to be movable around a vehicle 1. For example, the assembly device 300 may move on a rail 210 disposed in parallel with the vehicle 1. A pallet 220 may be disposed around the rail 210. The pallet 220 may provide the shark fin antenna 100 to be assembled on the vehicle 1. The assembly device 300 may pick the shark fin antenna 100 from the pallet 220 and assemble the shark fin antenna 100 to a mounting portion M provided on a roof 2 of the vehicle 1. The assembly system 200 may include a controller that controls operation of the assembly system 200. The controller may include a processor and a memory in which a set of commands executed by the processor are stored. The assembly system 200 may perform an assembly of the shark fin antenna 100 according to the commands pre-stored in the memory.

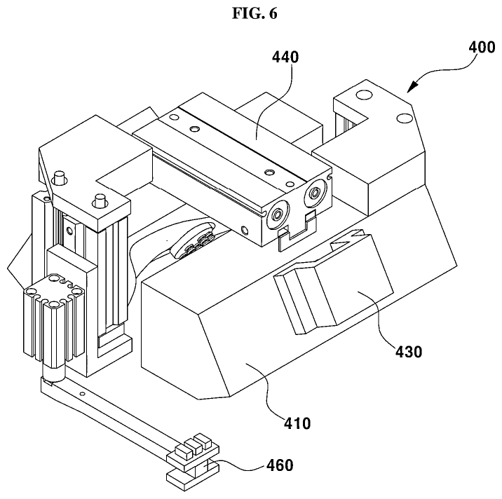

As shown in FIGS. 5 and 6, according to the present disclosure, the assembly device 300 may assemble the shark fin antenna 100 on the vehicle 1 through a gripper 400. According to the present disclosure, the gripper 400 may be designed to grip the shark fin antenna 100 that includes a three-dimensional curved surface. In addition, the gripper 400 may be provided with a driving portion 440 in order to drive the gripper 400. In one embodiment, the driving portion 440 may be a cylinder to which power is supplied.

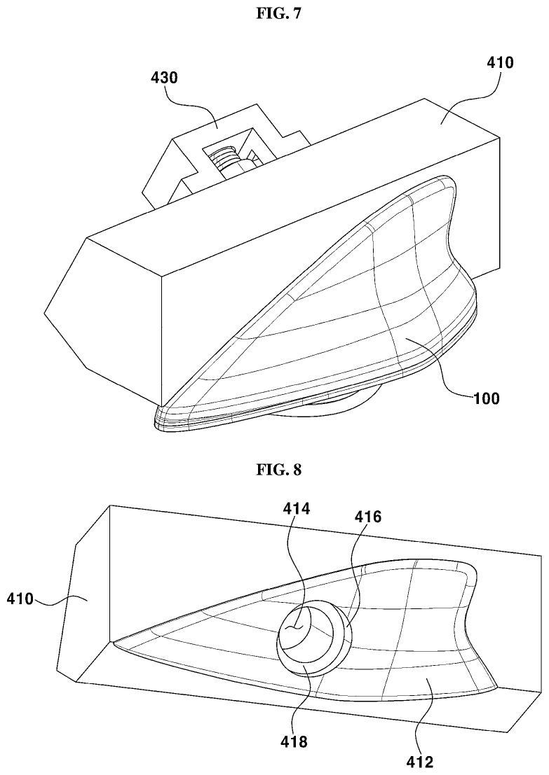

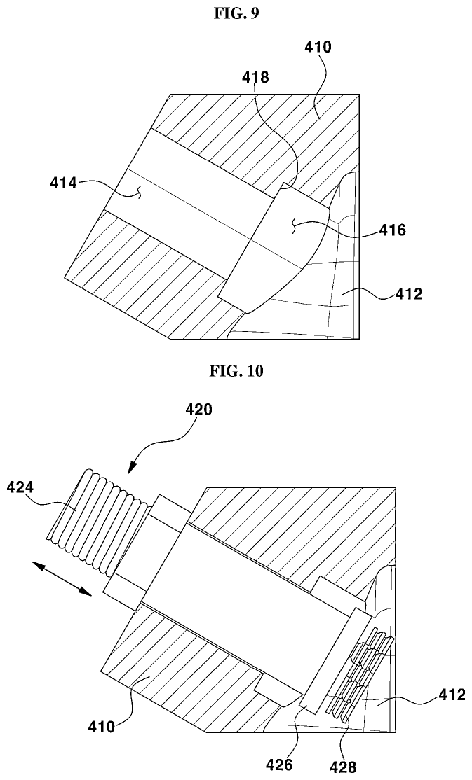

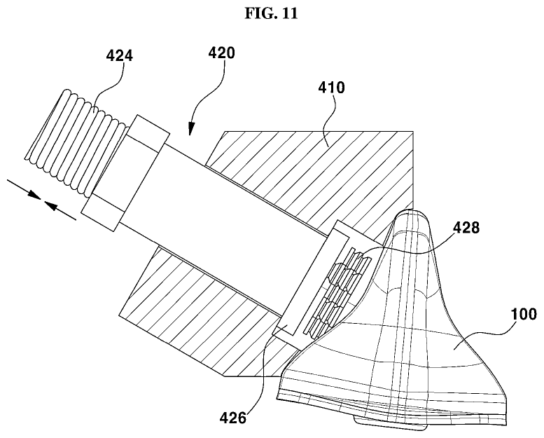

As shown in FIGS. 7 and 8, the gripper 400 may include an alignment frame 410. The alignment frame 410 is configured to support a three-dimensional curved surface of the shark fin antenna 100. To this end, the alignment frame 410 may include a surface 412 having the same shape as that of the outer surface of the shark fin antenna 100. To perform a gripping operation of the gripper 400, the gripper 400 may include a pair of alignment frames 410a and 410b facing each other.

As shown in FIGS. 9-11, the alignment frame 410 may be provided with a gripping module 420. The gripping module 420 may be configured to grip the shark fin antenna 100 supported by a surface 412 of the alignment frame 410.

The gripping module 420 may operate while penetrating through the alignment frame 410. The gripping module 420 is configured to be movable with respect to the alignment frame 410 and may move while penetrating through the alignment frame 410. To this end, the alignment frame 410 may be provided with a hole 414, and the gripping module 420 may be inserted into the hole 414. The gripping module 420 may move with respect to the hole 414.

As shown in FIGS. 12 and 13, a stopper housing 430 may be mounted on the alignment frame 410. The stopper housing 430 may be configured to cover at least a portion of the gripping module 420 such that a separation of the gripping module 420 is prevented and a movement of the gripping module 420 with respect to the alignment frame 410 is limited to a certain extent. In one embodiment, the stopper housing 430 may be integrally formed with the alignment frame 410 or may be formed separately and mounted on the alignment frame 410.

The stopper housing 430 may include a guide passage 432. In one embodiment, the guide passage 432 may be formed to be recessed from the stopper housing 430. The gripping module 420 may linearly move along the guide passage 432. The gripping module 420 may include a protrusion 422 protruding from the gripping module 420. The protrusion 422 may be inserted into the guide passage 432 and linearly move without a rotation movement.

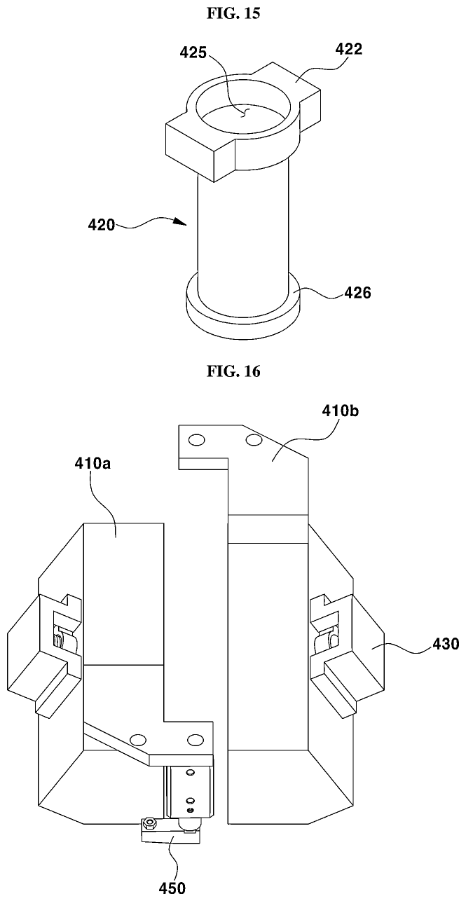

Referring to FIGS. 14 and 15, the gripping module 420 may include a spring 424. The spring 424 may be disposed to be supported by the stopper housing 430. In one embodiment, the stopper housing 430 may include a recess 434 formed to be recessed in the stopper housing 430. A first end of the spring 424 may be supported by the recess 434. In one embodiment, the gripping module 420 may include a seating portion 425. A second end of the spring 424 may be seated and supported by the seating portion 425. For example, the seating portion 425 may be formed to be recessed in the gripping module 420.

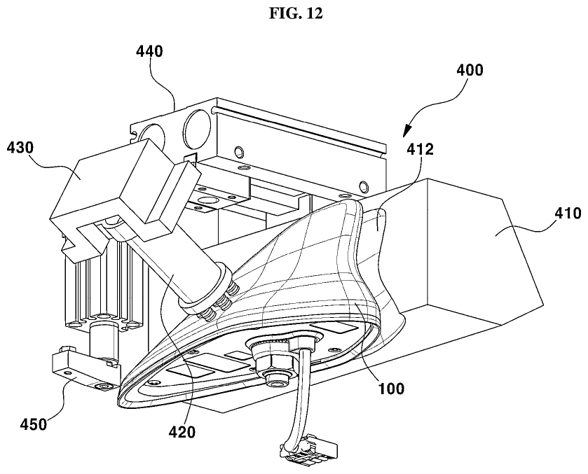

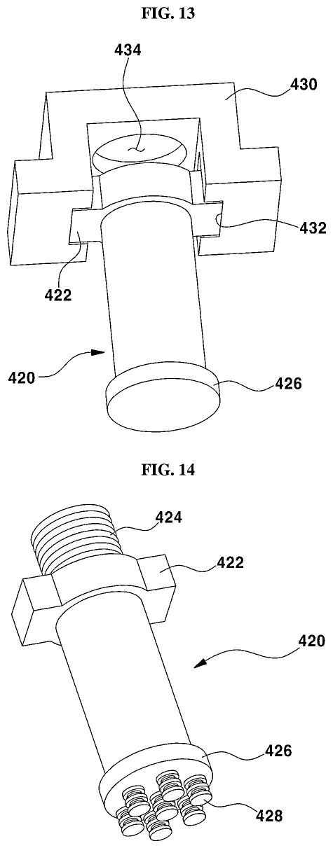

Referring to FIG. 10, in a general state where the gripper 400 is not clamping, the spring 424 is in an original position (e.g., decompressed position). With the spring 424 in the original position, the gripping module 420 is placed in an extended state while passing through the surface 412. Referring to FIG. 11, the spring 424 is compressed while the gripper 400 performs clamping. In the compressed state of the spring 424, the gripping module 420 is positioned within the alignment frame 410. The gripping module 420 may be pushed in the opposite direction with respect to the shark fin antenna 100 by the gripped shark fin antenna 100 and may be retained within the alignment frame 410 by the stopper housing 430 and a radial element 418. In one embodiment, the gripping module 420 may include a flange 426 that may mate (e.g., come into contact) with the radial element 418. In response, the alignment frame 410 may include an expansion hole 416. The flange 426 may be retained within the alignment frame 410 by the radial element 418 that connects the hole 414 with the expansion hole 416 in a radial direction. The hole 414 and the expansion hole 416 are coaxially positioned with each other, and the radial element 418 and the flange 426 enable an accurate alignment of the components.

The gripping module 420 may include a plurality of vacuum cups 428. Each vacuum cup 428 may be supplied with a vacuum generated from a vacuum generator (not shown) and perform a vacuum suction of the shark fin antenna 100. In one embodiment, the vacuum cups 428 may be formed to have a relatively small size with respect to the cross-sectional area of the gripping module 420. The gripping module 420 may include a plurality of vacuum cups 428 that have a relatively small size with respect to the cross-sectional area of the gripping module 420, thereby stably supporting and griping the three-dimensional curved shark fin antenna 100.

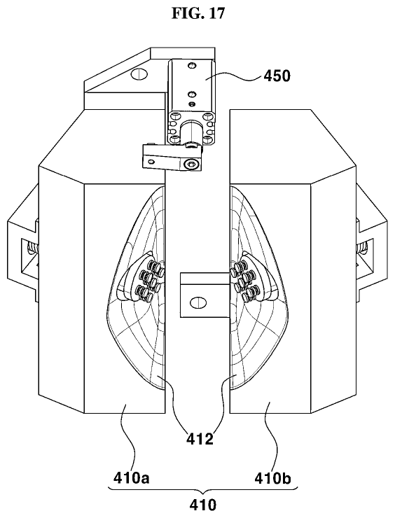

As shown in FIGS. 16 and 17, the gripper 400 may include a pair of alignment frames 410a and 410b that are operably coupled to each other. Each alignment frame of the pair of alignment frames 410a and 410b may be provided with the gripping module 420 and the stopper housing 430.

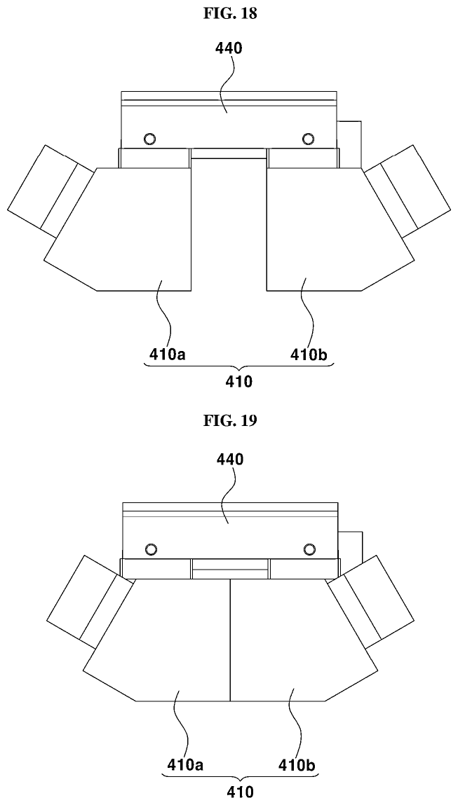

The pair of alignment frames 410a and 410b may be configured to be movable. The alignment frame 410 may be supplied with a moving force from the driving portion 440. As shown in FIGS. 18 and 19, the driving portion 440 may move the pair of alignment frames 410a and 410b in a direction toward or away from each other. When the shark fin antenna 100 is not gripped, the pair of alignment frames 410a and 410b may be spaced apart from each other. When the shark fin antenna 100 is gripped, the pair of alignment frames 410a and 410b may move toward each other and may not be substantially spaced apart from each other.

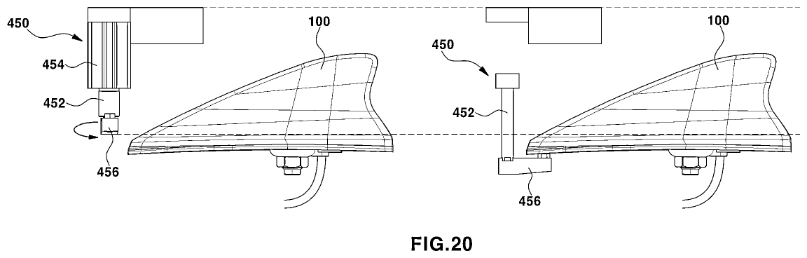

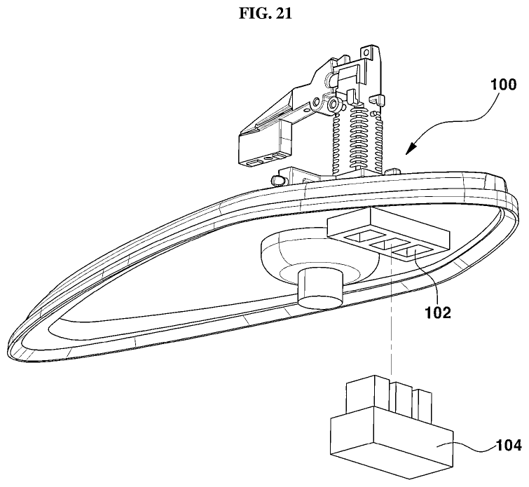

As shown in FIG. 20, the gripper 400 may include a support portion 450. The support portion 450 may prevent the shark fin antenna 100 from falling while being assembled. In one embodiment, the support portion 450 may include a rod 452, a drive cylinder 454, and a support element 456.

The rod 452 may be configured to be vertically movable and rotatable. In other words, the rod 452 may move up and down and rotate by the drive cylinder 454. In one embodiment, the drive cylinder 454 may be a device to which power is supplied. A support element 456 may be provided at the end portion of the rod 452. The support element 456 may be rotated together by the rotation of the rod 452 and may support the shark fin antenna 100.

Before the gripper 400 grips the shark fin antenna 100, the support element 456 may be disposed at an original position. At the original position of the support element 456, the support element 456 may be disposed in a substantially parallel and non-interfering way with the alignment frame 410. When the gripper 400 grips the shark fin antenna 100, the support element 456 may be rotated toward the alignment frame 410 or the shark fin antenna 100 by the driving of the drive cylinder 454. The rotated support element 456 may support a mounting surface of the shark fin antenna 100.

The gripper 400 according to the present disclosure may include an inspection module 460. The inspection module 460 may inspect whether a shark fin antenna 100 is mounted at a predetermined position on the vehicle 1. In other words, when the shark fin antenna 100 is assembled on the vehicle 1 as shown in FIG. 21, the inspection module 460 may verify that a female connector 102 formed on the mounting surface of the shark fin antenna 100 is positioned to be accurately engaged with a male connector 104 of the mounting portion M provided on the vehicle 1.

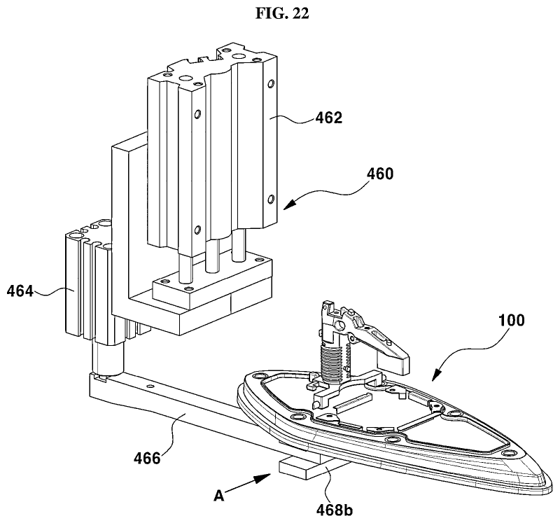

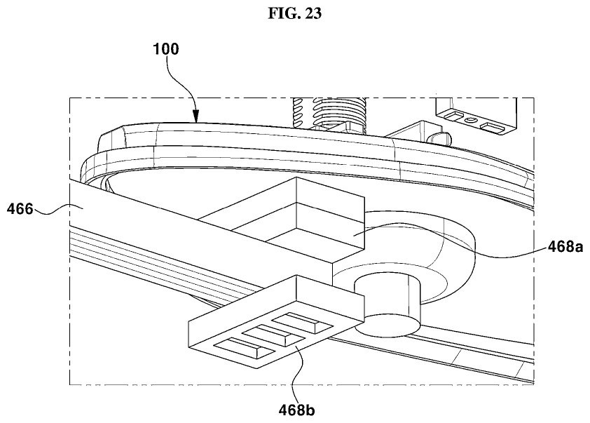

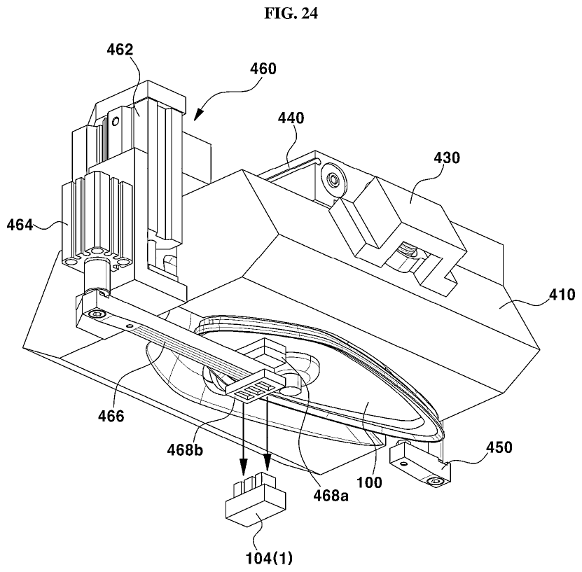

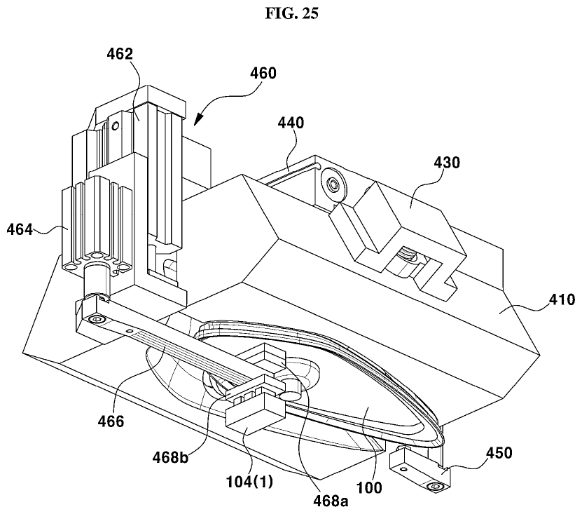

Referring to FIGS. 22 and 23, the inspection module 460 may include an elevation driving portion 462. The inspection module 460 may move up and down with respect to the alignment frame 410 by the elevation driving portion 462. In addition, the inspection module 460 may include a rotation driving portion 464. The inspection module 460 is configured to be rotatable by the rotation driving portion 464. In one example, the elevation driving portion 462 and the rotation driving portion 464 may include a motor, a cylinder, or the like to which power is supplied.

The inspection module 460 may include a bar 466. The bar 466 may move up and down and rotate with respect to the alignment frame 410 by the elevation driving portion 462 and the rotation driving portion 464.

The end of the bar 466 is provided with connector portions 468a and 468b. The connector portions 468a and 468b may include a male connector portion 468a and a female connector portion 468b. For example, an upper portion of the bar 466 may be provided with the male connector portion 468a that may be engaged with the female connector 102 of the shark fin antenna 100. Additionally, a lower portion of the bar 466 is provided with the female connector portion 468b that may be engaged with the male connector 104 of the vehicle 1.

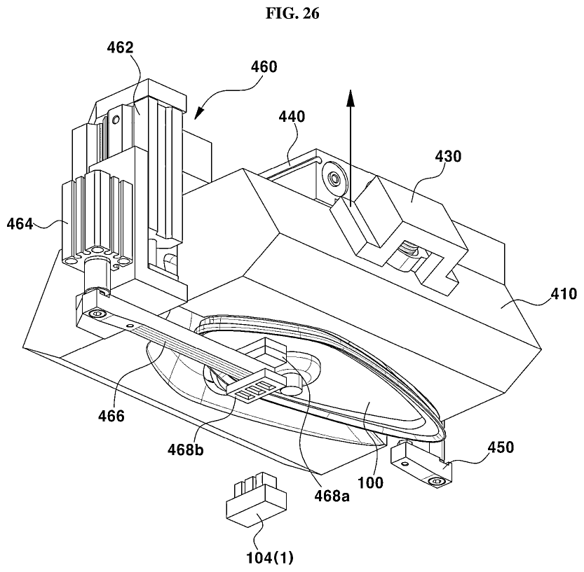

An assembly of the shark fin antenna 100 by the assembly system 200 according to an embodiment of the present disclosure is described below. A specific operation of the inspection module 460 is described with reference to FIGS. 24-29.

Referring to FIGS. 4 and 5, the assembly device 300 may grip the shark fin antenna 100 to be mounted on the mounting portion M from the pallet 220 via the gripper 400, and then may move the shark fin antenna 100 to the mounting portion M of the vehicle 1. When the shark fin antenna 100 is gripped by the gripper 400, the support portion 450 is rotated to support the gripped shark fin antenna 100. Also, the inspection module 460 may be rotated toward the gripped shark fin antenna 100.

The assembly device 300 may be configured to enter near the mounting portion M and approach a predetermined position close to the mounting portion M, e.g., to a height of 50 mm from the mounting portion M. When the assembly device 300 reaches a predetermined position, the support portion 450 may rotate in a direction away from the alignment frame 410 and return to its original position.

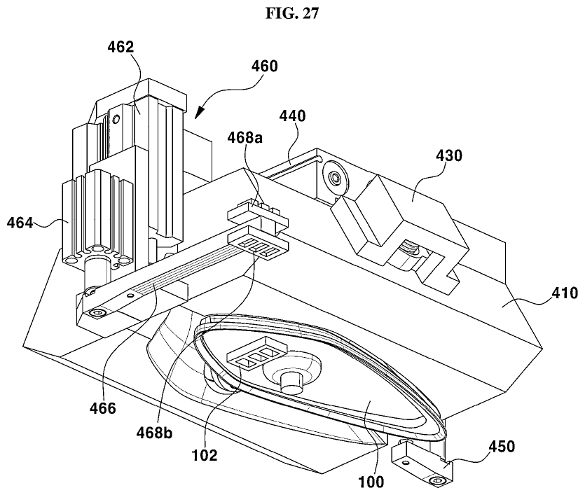

To determine compatibility, the inspection module 460 may be temporarily coupled to the female connector 102 and the male connector 104. Specifically, as illustrated in FIG. 24, the bar 466 may be rotated toward the gripped shark fin antenna 100. The assembly device 300 may lower the gripper 400 such that the male connector portion 468a is coupled to the female connector 102. Then, as illustrated in FIG. 25, the assembly device 300 may further lower the gripper 400 such that the female connector portion 468b is coupled to the male connector 104 provided on the mounting portion M of the vehicle 1.

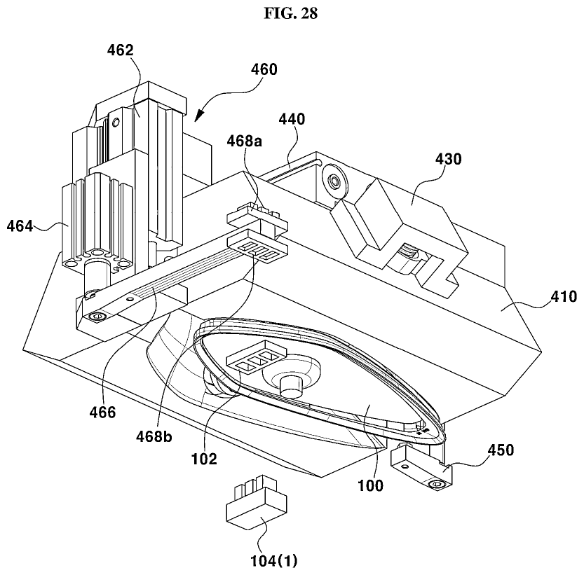

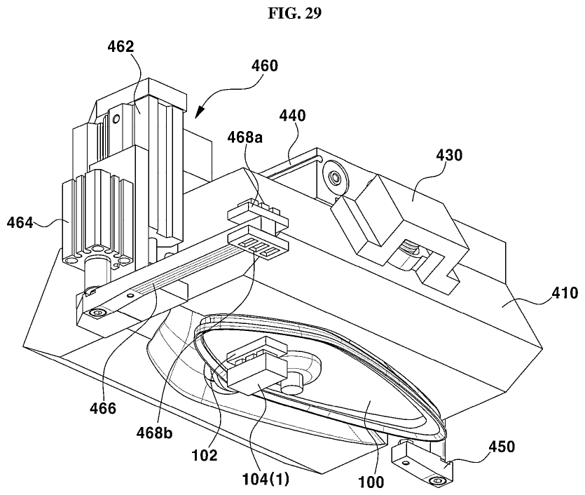

When it is determined that the connector portions 468a and 468b, and the male connector 104 are properly engaged together, based on an inspection circuit 470 of the inspection module 460, the assembly device 300 may raise the gripper 400 in a direction away from the male connector 104, as shown in FIG. 26. Simultaneously or sequentially, the bar 466 may be rotated in a direction away from the alignment frame 410 by the rotation driving portion 464 as shown in FIG. 27. As shown in FIGS. 28 and 29, the assembly device 300 may lower the gripper 400 such that the female connector 102 is coupled to the male connector 104 in order to ensure that the female connector 102 may be properly coupled to the male connector 104 in an inspected state. When the vacuum provided to the vacuum cup 428 is discontinued and the alignment frame 410 stops clamping, the mounting operation of the shark fin antenna 100 may be completed.

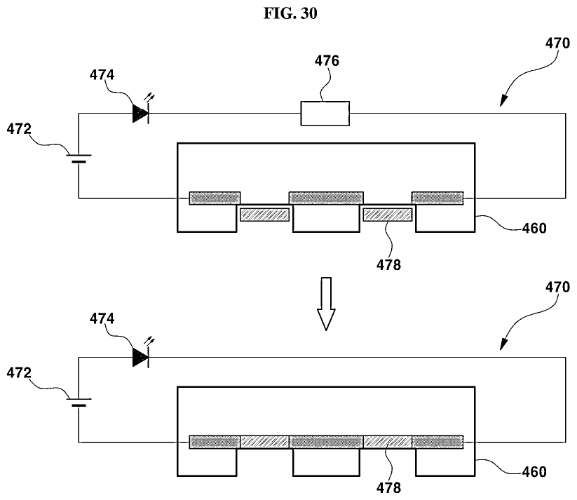

The inspection module 460 may determine whether the female connector 102 and the male connector 104 may be aligned with each other using the inspection circuit 470. Referring to FIG. 30, in one embodiment, the inspection circuit 470 may include a power source 472, a light emitting diode 474, a PLC 476 (programmable logic controller), and a tact switch 478. When the male connector portion 468a and the female connector portion 468b are engaged with the female connector 102 of the shark fin antenna 100 and the male connector 104 of the vehicle 1 respectively, the inspection circuit 470 may be closed by an operation of the tact switch 478. The light emitting diode 474 supplied with power from the power source 472 may be turned on. Accordingly, the PLC 476 of the inspection module 460 may determine that the female connector 102 of the shark fin antenna 100 and the male connector 104 of the vehicle 1 are in an exactly aligned position.

According to the embodiments of the present disclosure, an assembly method of a vehicle may include an assembly process of a shark fin antenna. In an embodiment, the assembly process may be performed by the assembly device 300 including the gripper 400.

According to the embodiments of the present disclosure, a vehicle may include a shark fin antenna that is assembled by an assembly device 300 including a gripper 400.

In this way, the assembly device including the gripper according to the present disclosure may easily assemble the shark fin antenna.

In addition, the assembly system including the gripper according to the present disclosure may automate the assembly of the shark fin antenna.

The present disclosure described above is not limited to the embodiments described above and the accompanying drawings. Additionally, it should be apparent to those having ordinary skill in the art that various substitutions, modifications, and changes may be made without departing from the technical idea of the present disclosure.

What is claimed is:

1. A device for installing a shark fin antenna, the device comprising a gripper configured to be multiaxially movable, wherein the gripper includes:
an alignment frame configured to support an outer side of a shark fin antenna;
a gripping module disposed in the alignment frame and configured to grip the shark fin antenna; and
an inspection module configured to inspect whether the shark fin antenna is assembled at a predetermined position on a vehicle.

2. The device of claim 1, wherein the alignment frame comprises a surface configured to correspond to a shape of the shark fin antenna.

3. The device of claim 1, wherein the gripping module is configured to grip the outer side of the shark fin antenna while penetrating through the alignment frame.

4. The device of claim 3, wherein the gripping module comprises a plurality of vacuum cups configured to grip the outer side of the shark fin antenna.

5. The device of claim 3, further comprising a spring supported by the alignment frame and the gripping module, wherein the gripping module is configured to be movable with respect to the alignment frame by a compression and extension of the spring.

6. The device of claim 5, wherein the alignment frame comprises a stopper housing in which the spring is disposed, and wherein a guide passage for guiding movement of the gripping module is formed in the stopper housing.

7. The device of claim 5, wherein the alignment frame comprises:
a hole into which the gripping module is inserted, wherein the hole includes a first hole and a second hole having a diameter larger than a diameter of the first hole; and
a radial element connecting the first hole and the second hole to each other in a radial direction,
wherein a flange is provided in the gripping module and the radial element, and
wherein the flanges of the gripping module and the radial element are configured to be operatively associated with each other so that a position of the gripping module is limited.

8. The device of claim 1, wherein the gripper further comprises a support portion connected to the alignment frame, and wherein the support portion is configured to support the shark fin antenna from a bottom of the shark fin antenna.

9. The device of claim 8, wherein the support portion is configured to be rotatable toward the alignment frame or away from the alignment frame, and wherein the support portion is configured to be vertically movable with respect to the alignment frame.

10. The device of claim 1, wherein the shark fin antenna comprises a female connector configured to be coupled to a male connector provided in the vehicle.

11. The device of claim 10, wherein:
the inspection module is operably connected to the alignment frame;
the inspection module further comprises a connector portion that is configured to connect to the female connector and the male connector; and
the inspection module is configured to determine whether the shark fin antenna is positioned at the predetermined position based on aligning the connector portion with the female connector and the male connector.

12. The device of claim 11, wherein the inspection module determines whether the shark fin antenna is assembled at the predetermined position by a closed circuit generated by combining the connector portion with the female connector and the male connector.

13. The device of claim 1, wherein the inspection module is operably connected to the alignment frame, and wherein the inspection module is configured to be elevated or rotated with respect to the alignment frame.

14. The device of claim 1, wherein the alignment frame comprises a pair of alignment frames movable with respect to each other, and wherein each alignment frame of the pair of alignment frames comprises a shape corresponding to the outer side of the shark fin antenna.

15. A system for assembling a vehicle, the system comprising:
a pallet providing a shark fin antenna that is to be assembled on a supplied vehicle; and
an assembly device configured to be movable and rotatable to pick up the shark fin antenna from the pallet.

16. The system of claim 15, further comprising a rail extending along the supplied vehicle, wherein the assembly device is disposed to be movable on the rail.

17. A method of assembling a vehicle, the method comprising automatically assembling a shark fin antenna on a vehicle by an assembly device.

18. The method of claim 17, wherein the assembly device comprises a gripper configured to be multiaxially movable, wherein the gripper comprises:
an alignment frame configured to support an outer side of the shark fin antenna; and
a gripping module disposed in the alignment frame and configured to grip the shark fin antenna.
